(19) United States
(12) Patent Application Publication
(10) Pub. No.: US 2026/0330579 A1
(43) Pub. Date: Oct. 22, 2026

(54) VOTER OUTREACH & REGISTRATION TRACKING SYSTEM

(71) Applicant: Jimmy Wagner, Brooklyn, NY (US)

(72) Inventor: Jimmy Wagner, Brooklyn, NY (US)

(21) Appl. No.: 19/531,667

(22) Filed: Feb. 6, 2026

Related U.S. Application Data
(60) Provisional application No. 63/755,162, filed on Feb. 6, 2025.

(51) Int. Cl. G06Q 50/22; G01C 21/00; G01C 21/34; G06Q 10/047

(52) U.S. Cl. CPC G06Q 50/22; G01C 21/3423; G01C 21/3878; G06Q 10/047

(57) ABSTRACT

A computer-implemented system and method for identifying, locating, and tracking individuals eligible to participate in a voting process but not registered as voters are disclosed. The system electronically aggregates heterogeneous data from multiple external sources, normalizes and cross-references the data to infer voter eligibility, and identifies eligible individuals absent from registration records. Geographic residence data is converted into machine-readable spatial coordinates and rendered within a dynamic multi-layer digital mapping interface. The system further performs spatial analysis to generate optimized outreach routes and provides navigation guidance to user devices. User engagement outcomes are received and persistently stored to update registration status and modify subsequent outreach planning through a closed-loop feedback process. The disclosed invention transforms fragmented static records into an integrated geospatial outreach platform, providing automated eligibility inference, real-time mapping, route optimization, and engagement tracking using computer-executed processes.

### CROSS REFERENCE TO RELATED APPLICATIONS

This application claims priority from a U.S. Provisional Patent Appl. No. 63/755,162, filed on Feb. 6, 2025, which is incorporated herein by reference in its entirety.

### FIELD OF INVENTION

The present invention relates generally to election support technologies, and more particularly, to a system and method for identifying, locating, and engaging individuals who are eligible to vote but are not registered to participate in a voting process. More specifically, the present invention relates to a system and method for voter outreach, data aggregation, and tracking voter registration status of eligible individuals.

### BACKGROUND

voting is a fundamental civic process by which eligible individuals express their preferences in an election to select representatives or decide public matters. In democratic systems, legislation and governance are carried out by elected representatives chosen through such elections. Applicable laws and regulations define voter eligibility criteria, which typically require individuals to complete a voter registration process prior to participating in an election.

Although voting is generally voluntary, the proportion of eligible individuals who participate in elections is widely regarded as an indicator of the health and effectiveness of a democratic system. Accordingly, governments, political parties, non-governmental organizations (NGOs), and civic groups frequently undertake initiatives aimed at encouraging eligible but unregistered individuals to register to vote. Such initiatives often include public awareness campaigns, community outreach programs, and door-to-door engagement efforts.

Despite these efforts, identifying and locating eligible but unregistered voters remains a complex and inefficient process. Information relevant to voter eligibility and registration status may exist across multiple disparate sources, including governmental databases, public records, and third-party datasets. However, such information is often fragmented, incomplete, outdated, or maintained in non-digital formats such as paper records or scanned documents. As a result, outreach organizations must rely on manual review, estimation, or redundant field efforts, making the process labor-intensive, time-consuming, and prone to error.

Consequently, there exists a need for a system and method that can efficiently identify, locate, and track eligible individuals who are not registered to vote, while consolidating relevant information from multiple sources to support targeted voter outreach and registration efforts. The present invention addresses these and other deficiencies of existing approaches.

### SUMMARY OF THE INVENTION

The following presents a simplified summary of one or more embodiments of the present invention to provide a basic understanding of certain features and advantages thereof. This summary is not an exhaustive overview of all contemplated embodiments and is not intended to identify key or critical elements of the invention or to delineate the scope of the claims. Rather, it introduces selected concepts that are further described in the detailed description.

In one embodiment, the present invention provides a computer-implemented system configured to identify, locate, and track individuals who are eligible to participate in a voting process but are not registered as voters.

In another embodiment, the present invention provides an automated engagement framework that simplifies voter outreach by supplying location-based guidance, engagement workflows, and real-time tracking of registration outcomes.

In one aspect, disclosed is a computer-implemented voter outreach and registration tracking system configured to aggregate data from a plurality of disparate sources, process the aggregated data to infer voter eligibility and registration status, and generate actionable outreach information presented through a dynamic, multi-layer digital mapping interface.

The system improves upon conventional voter outreach techniques by automating data normalization and reconciliation, reducing redundant field efforts, providing optimized navigation routing, and enabling real-time engagement tracking. In certain embodiments, the system operates as an intelligent assistance platform that guides outreach personnel through prioritized locations while continuously updating registration status based on field interactions.

In one aspect, disclosed is a method for voter outreach and registration tracking implemented using the disclosed system, the method comprising: importing voter registration data and eligibility-related data from one or more external sources; normalizing and standardizing the imported datasets; cross-referencing individuals across the datasets to infer voter eligibility; identifying eligible individuals absent from voter registration records; associating identified individuals with geographic residence locations; rendering a multi-layer dynamic digital map displaying residence and eligibility data; computing optimized outreach routes; presenting navigation and engagement instructions to a user; receiving user input indicative of outreach outcomes; and updating registration status and engagement tracking records in response to the received input.

The following presents a simplified summary of one or more embodiments of the present invention to provide a basic understanding of certain features thereof. This summary is not an exhaustive overview and is not intended to identify essential elements or limit the scope of the invention. Rather, it introduces selected concepts that are described in greater detail in the detailed description.

In one embodiment, the present invention provides a computer-implemented system configured to identify, locate, and track individuals who are eligible to participate in a voting process but are not registered as voters.

In another embodiment, the invention provides an automated outreach framework that transforms fragmented eligibility and registration data into actionable, location-based guidance using geospatial processing and real-time engagement tracking.

In one aspect, disclosed is a computer-implemented voter outreach and registration tracking system comprising one or more processors and memory storing executable instructions that cause the processors to import voter registration data and eligibility-related data from multiple heterogeneous external sources, normalize and cross-reference the data to infer voter eligibility, identify eligible individuals absent from registration records, associate such individuals with geographic residence locations, and render a dynamic multi-layer digital map displaying residence and eligibility information.

The system further executes spatial analysis routines to compute optimized outreach routes and presents navigation guidance and engagement instructions to user devices. User input indicative of outreach outcomes is received and persistently stored, and registration status and engagement tracking records are updated in real time. Updated engagement data dynamically modifies map overlays and routing guidance through a closed-loop feedback process.

In one aspect, disclosed is a computer-implemented method for voter outreach and registration tracking comprising electronically importing voter registration and eligibility data, normalizing and cross-referencing the data to infer voter eligibility, identifying eligible individuals absent from registration records, associating identified individuals with geographic locations, rendering a dynamic multi-layer digital map, computing optimized outreach routes, presenting navigation guidance, receiving engagement outcomes, and updating registration status and tracking records accordingly.

The disclosed embodiments provide concrete technical improvements over conventional outreach approaches, including automated aggregation of heterogeneous datasets, machine-driven eligibility inference, geospatial rendering, route optimization, and persistent engagement tracking. These operations collectively transform static records into an integrated, computer-executed geospatial outreach platform that improves data processing efficiency and enables location-aware decision support.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing the environment of the system, according to an exemplary embodiment of the present invention.

FIG. 2 is a block diagram showing the architecture of the system, according to an exemplary embodiment of the present invention.

FIG. 3 is a schematic diagram illustrating voter outreach, according to an exemplary embodiment of the present invention.

FIG. 4 is a flowchart illustrating operation flow of the disclosed system, according to an exemplary embodiment of the present invention.

### DETAILED DESCRIPTION

The subject matter of the present invention will now be described more fully with reference to the accompanying drawings, which form a part of this disclosure and illustrate specific exemplary embodiments. However, it should be understood that the subject matter may be embodied in various forms and is not limited to the specific embodiments set forth herein. Rather, these embodiments are provided by way of example to convey the scope of the invention. It is intended that the claims encompass a broad range of subject matter, including methods, devices, components, and systems. Accordingly, the following detailed description is not intended to be taken in a limiting sense.

As used herein, the term “exemplary” is intended to mean “serving as an example, instance, or illustration.” Any embodiment described as “exemplary” should not be construed as preferred or more advantageous over other embodiments. Similarly, the expression “embodiments of the present invention” does not imply that all embodiments must include all features, advantages, or modes of operation described.

The terminology used herein is for the purpose of describing particular embodiments only and is not intended to be limiting. As used herein, the singular forms “a,” “an,” and “the” include plural references unless the context clearly dictates otherwise. Furthermore, the terms “comprises,” “comprising,” “includes,” and/or “including” specify the presence of stated features, integers, steps, operations, elements, or components, but do not preclude the presence or addition of one or more other features, integers, steps, operations, elements, components, and/or groups thereof.

The following detailed description sets forth the best currently contemplated modes for carrying out exemplary embodiments of the invention. This description is not intended to be limiting, but rather to illustrate the general principles of the invention. The claims of any issued patent will define the scope of the invention.

The present invention relates to a computer-implemented system and method for identifying, locating, and tracking individuals who are eligible to vote but are not registered. Unlike conventional outreach approaches that rely on static lists or manual reconciliation of records, the disclosed system performs automated data aggregation, entity resolution, geospatial transformation, and route optimization to generate actionable outreach intelligence. The system consolidates heterogeneous datasets, executes eligibility inference logic, converts residency information into machine-readable geographic coordinates, and renders interactive navigation guidance through a dynamic digital mapping interface.

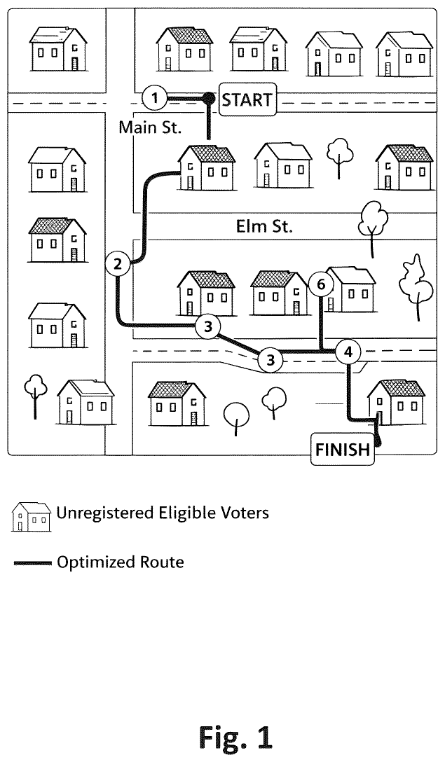

Referring to FIG. 1, an example graphical user interface is shown representing a defined geographic locality comprising multiple residences. The interface does not merely display a list of individuals; rather, the processor executes geospatial rendering routines that generate a multi-layer dynamic map. A first layer represents a base geographic layout of the locality, including streets and property boundaries. A second layer identifies individual residences within the locality. A third overlay layer visually distinguishes residences associated with one or more eligible but unregistered individuals. The system further computes inter-residence path connectivity and presents routing information linking residences based on spatial proximity.

In certain embodiments, the processor executes optimization algorithms that determine an efficient visitation sequence among identified residences, thereby minimizing travel distance or time for outreach personnel. The resulting plan of action is rendered as a selectable navigation layer that provides walking and/or driving guidance from a current user location to successive destinations.

In certain implementations, one or more layers of the dynamic mapping interface receive user input. Each residence may be represented by an interactive icon embedded with executable actions. Upon selection of a residence icon, the processor retrieves associated eligibility data and displays a contextual interface presenting engagement options, including viewing unregistered individuals associated with that residence. In alternative embodiments, such information is displayed automatically upon selection without requiring intermediate menu navigation.

In certain implementations, an additional selectable map layer displays quantitative indicators corresponding to the number of eligible unregistered individuals per residence. These indicators are generated dynamically based on real-time data maintained by the system.

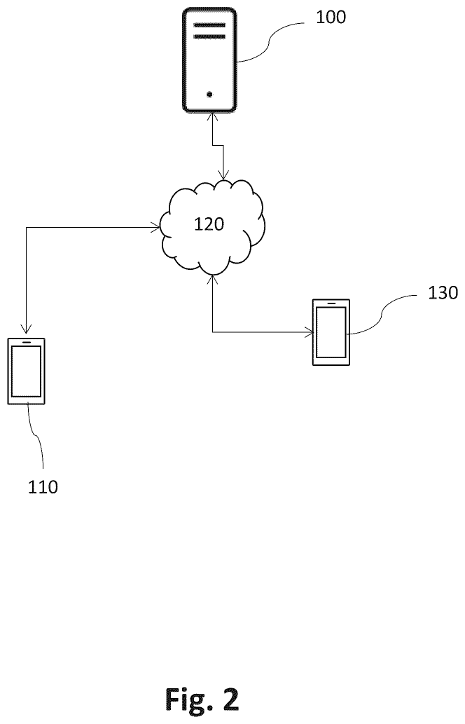

Referring to FIG. 2, an example system environment 100 is illustrated. The system 100 communicates with one or more user devices 110 via a network 120. The user device includes a processor, memory, input mechanisms, display circuitry, and networking components. Input mechanisms may include touchscreens, keyboards, styluses, mice, or similar devices. Output mechanisms may include LCD or OLED displays. Example user devices include smartphones, laptops, desktops, and workstations. The network 120 may comprise any wired or wireless communication network, including LAN, WAN, WLAN, MAN, cellular networks, or the Internet. Multiple networks may be utilized concurrently. The system 100 further communicates with external databases and servers 130, from which eligibility, registration, demographic, and geolocation data may be retrieved.

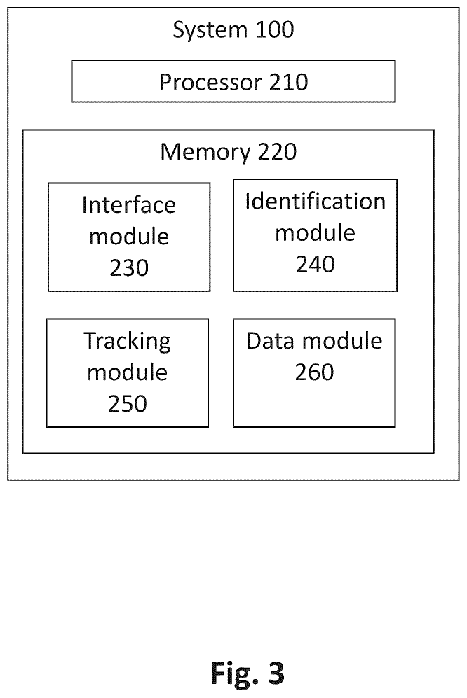

Referring to FIG. 3, the system 100 includes a processor 210 and memory 220 operably coupled thereto. The processor can be any logic circuitry that responds to, and processes instructions fetched from the memory. The memory may include one or more memory chips capable of storing data and allowing any storage location to be directly accessed by the processor. The memory stores executable instructions that, when executed by the processor, perform the disclosed operations, including data ingestion, normalization, eligibility inference, geospatial mapping, routing computation, and engagement tracking.

The memory includes an Interface Module 230, Identification Module 240, Tracking Module 250, and Data Module 260.

The term module as used herein and throughout this disclosure refers to software, a program code, a set of rules or instructions, and the like in one or more computer-readable languages including graphics, which upon execution by the processor performs one or more steps of the disclosed methodology. Also, operations may be described as a sequential process, some of the operations may be performed in parallel, concurrently, and/or in a distributed environment, and with program code stored locally or remotely for access by single or multi-processor machines. In addition, in some implementations, the order of operations may be rearranged without departing from the spirit of the disclosed subject matter.

The system can be implemented in the form of servers, which include cloud servers. The servers can be placed in one location or geographically dispersed. Also, one or more steps of the disclosed methodology can be performed on one or more user devices without departing from the spirit of the disclosed subject matter.

The Interface Module 230 generates a dynamic user interface that allows users to interact with the system. The interface supports multi-screen workflows, bidirectional data exchange, and real-time rendering of mapping and navigation outputs. The interface may be delivered via mobile applications, desktop applications, or web-based platforms.

The interface can be provided as an application software that can be installed on the user device. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the World Wide Web. The application software can also be provided for the desktop environment, such as Windows™, Linux, and macOS. The user interface may permit interaction with a user through the user device, wherein information can be presented within the user interface by system 100 and information can be received by system 100 from the user.

The Data Module 260 of the disclosed system is configured to import data from a plurality of heterogeneous sources, including but not limited to voter registration records; public eligibility data, including age and residency information; address and geolocation datasets; property and residency records; third-party demographic datasets; and user-generated field data collected during outreach efforts. Data may be received via APIs, structured databases, digitized documents, or semi-structured files.

Upon ingestion, the Data Module performs normalization operations including standardizing name and address formats, resolving data inconsistencies, and converting address information into standardized geospatial coordinates. The system performs entity resolution by correlating records across datasets using matching criteria such as name similarity, address correlation, date-of-birth ranges, and unique identifiers.

The Identification Module 240 executes logic instructions that analyze aggregated eligibility data to determine whether individuals meet predefined voter eligibility thresholds; compare identified eligible individuals against voter registration datasets; identify individuals who meet eligibility criteria but are absent from registration records; associate such individuals with specific residences or geographic locations. The identification process may be repeated periodically or dynamically updated as new data becomes available.

The system converts residency data into geospatial coordinates and renders those coordinates within a dynamic digital map. The interface supports multiple selectable overlay layers, including: a base geographic layout of a defined area; residences within the area; residences associated with one or more unregistered eligible individuals; quantitative indicators reflecting the number of unregistered individuals per residence.

The mapping interface allows user interaction with individual residence icons, enabling retrieval of associated eligibility and registration data. The processor executes spatial analysis routines that compute optimized outreach routes based on distance calculations, travel modality, and proximity clustering. These routes are dynamically generated and updated in response to user movement or data changes.

Navigation guidance may be generated for walking, driving, or hybrid transportation modes, thereby reducing redundant travel and improving outreach efficiency through computer-executed route optimization.

Through the Interface Module 230, users may select residences, view associated unregistered individuals, and record outreach outcomes including contact attempts and registration completions.

The Tracking Module 250 persistently records engagement data, updates registration status, and suppresses duplicate outreach efforts. User-provided feedback is reintegrated into system datasets, forming a closed-loop feedback architecture.

The disclosed invention provides concrete technical improvements over conventional outreach systems, including automated aggregation of fragmented datasets, machine-driven eligibility inference, real-time geospatial rendering, route optimization, and persistent engagement tracking. These operations collectively transform disparate static records into an integrated, computer-executed outreach platform that improves data processing efficiency, reduces computational redundancy, and enables location-aware decision support.

In certain embodiments, the disclosed system is implemented using one or more physical computing devices comprising processors, memory, network interfaces, and display controllers. The processors may include general-purpose CPUs, graphical processing units (GPUs), application-specific integrated circuits (ASICs), field-programmable gate arrays (FPGAs), or combinations thereof. The memory may comprise volatile and non-volatile storage including RAM, ROM, solid-state drives, or cloud-based storage systems. The system may operate in a distributed computing environment in which processing tasks, data storage, and mapping operations are performed across multiple networked servers and user devices. In such implementations, geospatial rendering, eligibility inference, routing computation, and engagement tracking may be executed asynchronously across different hardware nodes to improve performance and scalability.

The disclosed system executes machine-readable instructions that cause the processors to perform automated data ingestion, normalization, entity resolution, geospatial coordinate generation, dynamic map rendering, and route optimization. These operations are performed electronically and in real time using computer hardware.

The invention provides a specific technological solution that improves computer functionality by transforming fragmented static records into a dynamically updated, machine-executed geospatial outreach platform. The claimed system applies computing technology in a practical manner to generate actionable location-based guidance and automated engagement tracking, thereby providing a concrete improvement in data processing efficiency and spatial computing.

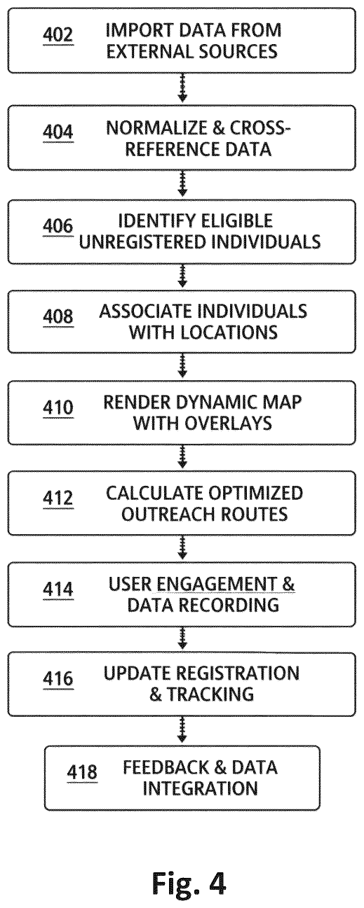

Referring now to FIG. 4, an example operational flow of the disclosed system is illustrated. The process begins at step 402, wherein the Data Module electronically imports voter registration records, eligibility datasets, geolocation information, property records, and third-party demographic data from multiple heterogeneous external sources via network interfaces.

At step 404, the processor executes data normalization routines that standardize name formats, address structures, and identifier fields. Address records are converted into machine-readable geospatial coordinates. The system further performs automated entity resolution by correlating records across datasets using matching algorithms based on name similarity, address correlation, date-of-birth ranges, and available unique identifiers.

At step 406, the Identification Module evaluates aggregated data attributes against predefined eligibility criteria to determine voter eligibility status. The processor then compares eligible individuals against voter registration datasets to identify individuals who satisfy eligibility requirements but are absent from registration records.

At step 408, the system associates identified unregistered individuals with specific residences and geographic locations. These locations are stored as coordinate-based records within a spatial database.

At step 410, the processor renders a dynamic digital map by executing geospatial visualization routines. The map includes multiple selectable overlay layers comprising a base geographic layout, residence locations, eligibility indicators, and quantitative metrics reflecting unregistered individuals per residence.

At step 412, the system performs spatial analysis and route optimization by calculating travel distances between residences and determining an efficient visitation sequence based on geographic proximity and selected transportation mode. Optimized navigation routes are generated and presented to the user through the Interface Module.

At step 414, the user interacts with residence icons displayed on the map to retrieve associated eligibility information and outreach instructions. The system presents engagement workflows allowing the user to record contact attempts, registration outcomes, and additional field observations.

At step 416, user-provided engagement data is received by the Tracking Module and persistently stored. Registration status records are updated in real time, and completed residences are removed or deprioritized from subsequent routing computations to prevent redundant outreach.

At step 418, the system reintegrates updated engagement data into its datasets, thereby dynamically modifying map overlays and routing guidance. This feedback-driven loop enables continuous refinement of outreach planning and real-time synchronization between field activity and system intelligence.

The operational flow described above illustrates a closed-loop computer-executed process in which disparate datasets are transformed into actionable geospatial guidance, and user interactions continuously update system state. These steps collectively represent a practical application of computing technology involving automated data processing, spatial computation, and persistent engagement tracking.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A computer-implemented voter outreach and registration tracking system comprising:
one or more processors;
memory operably coupled to the one or more processors and storing executable instructions that, when executed, cause the one or more processors to:
import voter registration data and eligibility-related data from a plurality of heterogeneous external data sources via a network;
normalize the imported data by standardizing identifier and address formats and converting residency information into geospatial coordinates;
cross-reference individuals across the normalized data to infer voter eligibility;
identify individuals who satisfy eligibility criteria and are absent from voter registration records;
associate identified individuals with geographic residence locations;
render a dynamic multi-layer digital map comprising at least a base geographic layer, a residence layer, and an eligibility overlay layer;
execute spatial analysis routines to compute optimized outreach routes between residence locations;
present navigation guidance and engagement instructions to a user device;
receive user input indicative of outreach outcomes; and
update registration status and engagement tracking records in response to the received user input,
wherein the system continuously modifies the digital map and outreach routes based on updated engagement data.

2. The system of claim 1, wherein the heterogeneous external data sources comprise voter registration databases, demographic datasets, property records, geolocation services, and user-generated outreach data.

3. The system of claim 1, wherein the normalization includes entity resolution performed using matching criteria comprising name similarity, address correlation, date-of-birth ranges, and unique identifiers.

4. The system of claim 1, wherein the dynamic multi-layer digital map includes selectable overlays indicating a quantity of unregistered eligible individuals associated with each residence.

5. The system of claim 1, wherein the spatial analysis routines generate optimized outreach routes based on distance calculations, geographic proximity, and selected transportation modes.

6. The system of claim 1, wherein the navigation guidance supports walking, driving, or mixed transportation modes.

7. The system of claim 1, wherein the user input comprises contact attempts, registration completions, and field observations.

8. The system of claim 1, wherein the engagement tracking records suppress redundant outreach to residences already contacted.

9. The system of claim 1, wherein the processors execute a closed-loop feedback process that reintegrates engagement outcomes into subsequent routing computations.

10. A computer-implemented method for voter outreach and registration tracking, comprising:
electronically importing voter registration data and eligibility-related data from multiple external sources;
normalizing the imported data by standardizing identifiers and converting address information into geospatial coordinates;
cross-referencing individuals across the normalized data to infer voter eligibility;
identifying eligible individuals absent from voter registration records;
associating identified individuals with geographic residence locations;
rendering a dynamic multi-layer digital map displaying residence and eligibility data;
executing spatial analysis to compute optimized outreach routes;
presenting navigation guidance and engagement instructions to a user device;
receiving user input indicative of outreach outcomes; and
updating registration status and engagement tracking data based on the received user input,
wherein updated engagement data dynamically modifies the digital map and outreach routing.

11. The method of claim 10, further comprising displaying quantitative indicators of unregistered individuals per residence.

12. The method of claim 10, wherein the spatial analysis accounts for transportation mode and geographic proximity.

13. The method of claim 10, further comprising suppressing outreach to residences having completed registration records.

14. The method of claim 10, wherein eligibility inference is performed using automated matching algorithms.

15. The method of claim 10, wherein engagement outcomes are persistently stored to provide continuous system refinement.
